(19) United States
(12) Patent Application Publication
(10) Pub. No.: US 2008/0245034 A1
(43) Pub. Date: Oct. 9, 2008

(54) INVISIBLE PRINTED MARKING

(75) Inventor: Klaus Topfer, Buttelborn (DE)

Correspondence Address: HAHN LOESER & PARKS, LLP, One GOJO Plaza, Suite 300, AKRON, OH, 44311-1076, US

(73) Assignee: POLY-CLIP SYSTEM GMBH & CO. KG, Frankfurt/Main (DE)

(21) Appl. No.: 12/061,721

(22) Filed: Apr. 3, 2008

(30) Foreign Application Priority Data
Apr. 3, 2007 (DE) 20 2007 004 908.0

(51) Int. Cl. B65B 61/02; B65B 9/20; B41F 17/10

(52) U.S. Cl. 53/411; 53/550; 347/106; 53/64

(57) ABSTRACT

An apparatus for the production of film tube, which can be filled with liquid, viscous or granular filling material, from a film strip. The apparatus comprises: a filling pipe connectable to a filling machine for the filling material, a shaping device surrounding the filling pipe for shaping the film strip into a film tube, a sealing device arranged downstream of the shaping device in the filling ejection direction for sealing longitudinal edges of the film strip, which are adjacent after the shaping operation, to form a film tube, an advance drive for the film tube, a writing device arranged upstream of the shaping device in the filling ejection direction for applying printed markings to the film strip, a first reading device arranged downstream of the shaping device in the filling ejection direction and a second reading device) arranged upstream of the shaping device in the filling ejection direction for reading printed markings applied to the film strip. The writing device is capable of applying to the film strip at least one printed marking whose electromagnetic spectrum is outside visible light and the first and the second reading devices are capable of detecting said printed markings.

The invention concerns an apparatus for the production of film tube, which can be filled with liquid, viscous or granular filling material, from a film strip, and a film strip for that purpose.

In particular the invention concerns an apparatus for the production of film tube, which can be filled with liquid, viscous or granular filling material, from a film strip, wherein the apparatus includes: a filling pipe connectable to a filling machine for the filling material, a shaping device surrounding the filling pipe for shaping the film strip into a film tube, a sealing device arranged downstream of the shaping device in the filling ejection direction for sealing longitudinal edges of the film strip, which are adjacent after the shaping operation, to form a film tube, an advance drive for the film tube, a writing device arranged upstream of the shaping device in the filling ejection direction for applying printed markings to the film strip, a first reading device arranged downstream of the shaping device in the filling ejection direction and a second reading device arranged upstream of the shaping device in the filling ejection direction, wherein both reading devices are provided for reading printed markings applied to the film strip.

It is known for the tubular case required for the production of sausages or similar portion packs to be continuously or intermittently produced by means of such an apparatus on site by longitudinal seam sealing of a film strip which is shaped to put it into a tubular form. In that respect the term sealing is used to denote any kind of (non-releasable) connection of the two longitudinal edges, this also including, for example, welding as a preferred sealing procedure, but also the use of adhesive, or the like. In the apparatus of the general kind set forth, which is known from European patent application No 0 908 103 (U.S. Pat. No. 6,146,261), the film strip is pulled over a suitable shaping device (shaping shoulder) and through the sealing or welding device, by the advance drive that is arranged downstream of the sealing device in the region or in the transport or filling ejection direction. The shaping shoulder surrounds the filling pipe and shapes the film strip around the filling pipe to put it into a configuration such that the longitudinal edges thereof adjoin each other either in butting relationship or overlapping relationship. Those longitudinal edges are connected together in the subsequent welding or sealing apparatus directly or by means of a sealing strip which joins the edges.

The film tube formed in that way is further conveyed by the advance drives in the filling ejection direction into a buffer portion on the filling pipe in which it is folded in a concertina-like configuration to provide a supply thereof. A supply is necessary as the filling operation of introducing the filling material into the film tube takes place intermittently and the sealing operation in most cases takes place continuously, in some cases also intermittently, but at any event more slowly than the withdrawal of the film tube from the filling pipe, which is governed by ejection of the filling material during the filling operation. On the other hand, after the filling operation, there are pauses while the ends of the filled film tube are closed by means of what is referred to as a clipping machine. Therefore the film tube continues to be produced during the clipping pauses (filler stoppage) in which the filling operation is stopped. In that situation the supply of film tube accumulates in front of a retaining means.

In order to achieve synchronization between production of the film tube and the filling operation, it is known for film tube production to be regulated. That purpose is achieved by using a measuring device for determining a supply amount for the film tube, that device typically comprising a sensor element which is movable with respect to the filling pipe and a stationary sensor element. The movable sensor element is connected to an entrainment member which engages into the cross-section of the folded or gathered film tube and which at the same time forms the retaining means for the supply of film tube. When the supply of film tube is increased in size, that displaces the entrainment member and the movable sensor element in the delivery direction of the advance drives against a return force which is applied, for example, by a spring (spring force) or a pneumatic member (pressure force). When film tube is withdrawn from the supply thereof and the supply is thus reduced in size, the return force then drives the entrainment member with the movable sensor element back in opposite relationship to the conveyor direction.

In the simplest design configuration of the measuring device, the fixed sensor element has, for example, two spaced mechanical or magnetic switches or signal generators, which are respectively actuated upon the approach of the movable sensor element (mechanical or contactless contact surface). In that situation the switches cause the apparatus to be switched off or switched on respectively, at a preset maximum or minimum supply amount respectively that is selected by a suitable relative arrangement of the switches/signal generators and the contact surfaces.

A further development of that measuring device provides for travel measurement between the movable and the stationary sensor elements, the result thereof allowing differentiated adaptation of the sealing and conveyor speed to the supply amount.

In any case however, the movable sensor element is transported by the entrainment member that engages into the cross-section of the gathered film tube. That presupposes in each case adequate folding of the supply of film tube, at which the entrainment member engages it. Now however there are films with coatings that suffer damage due to severe folding. For example, films with an aluminum coating are sensitive to sharp bends as the relatively brittle aluminum layer can tear at such locations, whereby both the functional and also the aesthetic properties of the film are impaired. The same applies to stiff film materials that can no longer be completely smoothed again after sharp shapes have been formed therein and thus retain an irreversible, undesirably wavy structure. The problem that also arises is that the folds of the film that is still hot after the sealing operation stick to each other in the event of an excessively high accumulation pressure during the formation of the supply of film tube.

A further possible way of determining and controlling the supply of film tube is to apply markings to the film strip or the film tube. In that case, a writing device such as, for example, a printer applies a suitable marking, for example, to the film strip at predetermined spacings. A reading device detects those markings and thus determines the length of the film strip drawn from the supply of film strip. In the sealing device, the film strip is processed to produce the film tube and forms the supply of film tube, as described above. A further reading device disposed in the proximity of the front end of the filling pipe, in the filling ejection direction, detects the length of the film tube withdrawn from the supply thereof. The currently prevailing length of the supply of film tube is determined from the difference in the length of the film strip withdrawn from the supply of film strip and the film tube withdrawn from the supply of film tube. Furthermore, the speed of production of the film tube can be influenced on the basis of the respectively current length of the supply of film tube in such a way that the supply of film tube remains approximately constant in a predetermined region.

Such markings however can adversely affect the visual impression of the finished product. Depending on the respective size, shape and color of the markings they cover over, for example, the images and inscriptions that are usually already applied to the film strip in the production thereof. Controlling the applied printing in such a way that the printing on the existing film strip is not adversely affected is either highly complicated and expensive or is impossible depending on the respective size of the printing.

### SUMMARY OF THE INVENTION

An object of the present invention is to provide an apparatus and a film strip for the production of film tube from said film strip, which overcome those disadvantages. A further object of the invention is to permit the application of printed markings at any locations on the film strip.

In particular, the foregoing object is attained by an apparatus of the kind described above, in which a writing device is capable of applying to the film strip at least one printed marking whose electromagnetic spectrum is outside visible light and wherein the first and the second reading devices are capable of reading said printed marking. Such printed markings can be applied at any desired location on the film strip or the film tube as they are not visible to the consumer and thus do not adversely affect the appearance of the finished product.

In the simplest case, those markings are visible under UV light as a mature technology is available for such uses. In general, the electromagnetic spectrum of the printed markings however should be in a wavelength range that is less than 380 nm and greater than 780 nm. That wide spectrum means, for example, that it is also possible to use infrared radiation. A further preferred range is one which is less than 350 nm and greater than 800 nm, whereby it is possible to ensure that the markings are actually visible only with technical aids.

In particular, the object is attained in respect of the film strip in that the film strip is provided with at least one printed marking, the electromagnetic spectrum of which is outside visible light. If the printed markings are, for example, already to be found on the film strip when the film strip is fitted into the apparatus according to the invention, it is possible to forego the provision of a corresponding writing unit.

It will be appreciated that the reading devices and the writing device for the printed markings must be matched to each other. It is therefore advantageous if the printed markings of the film strip are readable by the first and the second reading devices.

Preferably, the electromagnetic spectrum of the printed markings of the film strip should be in a wavelength range that is less than 380 nm and greater than 780 nm. In that respect, it is particularly preferred if the electromagnetic spectrum is less than 350 nm and greater than 800 nm.

The printed markings on the film strip can be distributed as desired. In a preferred embodiment the distribution is uniform. In that way, a given length of film strip can always be associated with a given number of markings.

The distribution of the printed markings on the film strip can also be irregular. Such a distribution can be advantageous if, for example, when using the same film strip, that is to say while maintaining the diameter involved, the length of the product is to be altered.

Usually sausage products are provided with product-specific or manufacturer-specific data, for example, by means of stickers that are applied to the product after manufacture. If such data or also images are already arranged on the film strip in the production thereof, that working step can be omitted in or prior to production of the film tube or after the sausage product is finished.

In an advantageous configuration of the film strip, the printed markings applied on the film strip by the writing device are applied independently of the position of the product-specific or manufacturer-specific identifications. As a result, apparatuses and working steps for coordinating the printed marks and the product-specific or manufacturer-specific identifications are eliminated.

### BRIEF DESCRIPTION OF THE DRAWING FIGURES

Further objects, features and advantages of the present invention will now be described by means of the embodiments described by way of example hereinafter with reference to the associated Figures in which:

FIG. 1 shows a diagrammatic view of an embodiment of the apparatus according to the invention for the production of film tube, as a side view, and

FIG. 2 shows a plan view of the embodiment of FIG. 1.

### DETAILED DESCRIPTION

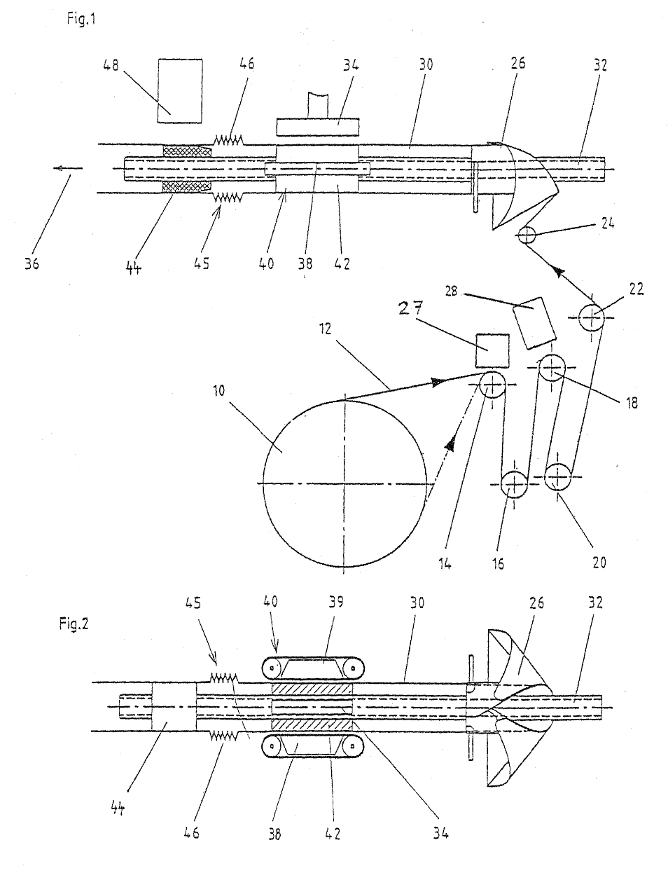

The apparatus shown in FIG. 1 has a supply roll 10 of a film strip 12 that is waiting to be processed. The film strip 12 is passed over a plurality of direction-changing rollers 14, 16, 18, 20, 22 and 24 to a shaping shoulder 26. A writing device 27 is disposed in the region of the direction-changing roller 14. Arranged in the region of the direction-changing roller 18 is a first reading device 28 of a measuring device, on the surface of the film strip 12 in opposite relationship to the direction-changing roller 18.

The film strip 12 is shaped into a film tube 30 around a filling pipe 32 in the shaping shoulder 26. In that case, the film tube 30 substantially coaxially surrounds the filling pipe 32. After the shaping operation, the film tube 30 has two adjacent longitudinal edges that are disposed upwardly in the view in FIG. 1 but which are not illustrated and which are sealed or welded in a sealing station 24 arranged downstream of the shaping shoulder 26 in the filling ejection direction (see the arrow 36). Disposed at the same level as the sealing station 34 on both sides of the filling pipe 32 is a respective drive belt 38, 39, which bears against the outside of the film tube 30, of an advance drive 40 that pulls the film strip 12 forward and under the sealing station 34 and at the same time pushes the finished film tube 30 in the filling ejection direction 36. A ring 42 is arranged in the region of the sealing station 34 and the advance drive 40, in coaxial relationship on the filling pipe 32. The outside diameter of the ring 42 approximately corresponds to the diameter of the finished film tube 30. Both the drive belts 38, 39 and also the sealing station 34 (more precisely a sealing bar, a sealing strip or a hot air flow of the sealing station) act under a pressure against that ring 42.

A retaining ring 44 is disposed coaxially on the filling pipe 32 downstream of the sealing station 34. As the advance drive 40 acts in the advance direction upstream of the retaining ring 44 and as the film tube 30 does not have adequate inherent stability, a film tube supply 46, which is folded in a concertina-like configuration, is formed on a buffer section 45 between the retaining ring 44 and the advance drive 40. Because however the severity of the folding is not an important consideration in the apparatus according to the invention, that folding can be reduced, for example, having regard to the delicacy of the film material, by virtue of a suitable choice of the length of the buffer section 45 with the same supply capacity or with a predetermined length of the buffer section 45 by a reduction in the amount in the supply.

The film tube 30 is then withdrawn from the buffer supply over the retaining ring in the filling operation in the filling ejection direction. A second reading device 48 of the measuring device is disposed at the level of the retaining ring 44 or downstream thereof in the filling ejection direction 36, that is to say at the location at which the film is straightened again by being withdrawn from the supply 46.

As can further be seen from FIG. 1 the writing device 27 for applying printed markings to the film strip 12 is disposed immediately downstream of the supply roll 10 in the filling ejection direction 36. The first reading device 28 registers the markings applied to the film strip 12 by the writing device 27 and determines therefrom the length of the film strip 12 withdrawn from the supply roll 10, with the spacing of the markings being known.

As the film strip 12 is neither upset nor extended in its longitudinal extent as far as the sealing station 34, the length of the film strip 12 withdrawn from the supply roll 10 precisely corresponds to the length of the film tube 30 which is delivered by the sealing station 34 to the buffer section 45.

As already described hereinbefore, in the filling operation, the film tube 30 is withdrawn from the folded buffer supply over the retaining ring 44 in the filling ejection direction. In that situation the folded film tube 30 is straightened out again. The second reading device 48 disposed directly at the retaining ring 44 determines the length of film tube 30 withdrawn from the buffer section 45, on the basis of the printed markings applied to the film strip 12 by the writing device 27.

On the basis of the difference between the lengths, ascertained as described hereinbefore, of the film tube 30 that is fed to the buffer section and withdrawn therefrom, it is possible to exactly determine the length of the supply 46 of film tube at any time and to influence it in a specifically targeted fashion by suitable control of the advance drive 40.

It is to be seen that, in the application of printed markings whose electromagnetic spectrum is outside visible light to the film strip 12, the product-specific or manufacturer-specific identifications already disposed thereon are not adversely affected. Therefore, the printed markings can be applied to the film strip 12 at any location, according to the suitability for the above-described regulation of the length of the supply 46 of film tube.

The process for the production of film tube 30, which can be filled with liquid, viscous or granular filling material, from a film strip 12 by means of the apparatus according to the invention is described hereinafter. In a first step, the film strip 12 is fed to the shaping device 26 from the film strip supply 10. Directly downstream of the film strip supply 10 the writing unit 27 continuously applies printed markings to the film strip 12 at previously defined spacings. The reading device 28 registers the length of the film strip 12 that has been drawn off, on the basis of the markings. In the shaping device 26 the film strip 12 is shaped around a filling pipe 32 to give a film tube 30 and is thereafter welded or sealed in a welding or sealing device 34 at the longitudinal edges which after the shaping operation overlap or are in mutually juxtaposed relationship, with or without using an additional sealing strip, to afford the closed film tube 30. Thereafter, the sealed film tube 30 is delivered by means of the advance drive 40 from the sealing station 30 to the supply 46 of film tube on the filling pipe 32 from which it is withdrawn again as required, governed by the filling operation. In that case, the length of the film tube 30 withdrawn from the supply 46 of film tube is detected by the second reading device 48 and fed to an (electronic) regulation system, just like the length, detected by the first reading device 28, of the film strip 12 withdrawn from the film strip supply 10. The electronic regulating system regulates the sealing operation or the sealing speed in such a way that a predetermined supply amount, which remains as uniform as possible, of film tube 30 is maintained on the buffer section 45.

At the beginning of operation or upon a change in the film strip, firstly a given amount of film tube 30 has to be pre-sealed so that satisfactory starting of the overall installation (sealing apparatus and clipping machine) is guaranteed. That given amount can then be maintained by the measurement and regulation of the sealing speed in accordance with the invention.

In the embodiment shown in FIG. 1, the writing device 27 is part of the apparatus according to the invention. It will be appreciated that a printed marking according to the invention can already be applied to the film strip 12 during manufacture thereof. The provision of a writing device would then no longer be necessary.

The printed markings according to the invention are only visible to the human eye when using aids and do not adversely affect the appearance of the finished product for the consumer. Therefore, they can also perform other functions, besides determining the length of the film tube supply 46 on the buffer section 45. They can contain further items of information which, for example, can be used for monitoring purposes.

In addition, the use of the printed markings according to the invention makes it possible, for example, to produce a central printed image of the product-specific or manufacturer-specific identifications without having to pay attention to the position of the printed markings.

It will be appreciated that it is also possible to provide a writing unit that applies printed markings which are ‘normal’, that is to say visible to the human eye, to the film strip 12. It will be appreciated that in that case the reading devices 28, 48 must also be capable of detecting those markings.

The writing device 27 can also be disposed at any other location between the film strip supply 10 and the sealing device 34. In that case however it is to be noted that the reading device 28 must also be provided at a correspondingly altered position.

1. Apparatus for the production of film tube, which can be filled with a filling material, from a film strip, comprising:
a filling pipe connectable to a filling machine for the filling material;
a shaping device surrounding the filling pipe for shaping the film strip into a film tube;
a sealing device arranged downstream of the shaping device in the filling ejection direction for sealing longitudinal edges of the film strip, which are adjacent after the shaping operation, to form a film tube;
an advance drive for the film tube;
a writing device arranged upstream of the shaping device in the filling ejection direction for applying printed markings to the film strip; and
a first reading device arranged downstream of the shaping device in the filling ejection direction and a second reading device arranged upstream of the shaping device in the filling ejection direction for reading the printed markings applied to the film strip,
where the writing device is capable of applying to the film strip at least one printed marking whose electromagnetic spectrum is outside visible light and that the first and the second reading devices are capable of detecting said printed markings.

2. The apparatus as set forth in claim 1 where the electromagnetic spectrum of the printed markings is in a wavelength range which is less than 380 nm and greater than 780 nm.

3. The apparatus as set forth in claim 2 where the electromagnetic spectrum of the printed markings is in a wavelength range which is less than 350 nm and greater than 800 nm.

4. The apparatus as set forth in claim 1 where the film strip includes any desired printed image of product-specific or manufacturer-specific identifications.

5. A film strip for the production of film tube which can be filled with a filling material comprising:
a length of film; and
at least one printed marking on the film, the electromagnetic spectrum of which is outside visible light.

6. The film strip as set forth in claim 5 where the electromagnetic spectrum of the printed markings of the film strip is in a wavelength range which is less than 380 nm and greater than 780 nm.

7. The film strip as set forth in claim 6 where the electromagnetic spectrum of the printed markings of the film strip is in a wavelength range which is less than 350 nm and greater than 800 nm.

8. The film strip as set forth in claim 5 where the distribution of the printed markings on the film strip is uniform.

9. The film strip as set forth in claim 5 where the distribution of the printed markings on the film strip is irregular.

10. The film strip as set forth in claim 5 where the printed markings are arranged in the region of product-specific or manufacturer-specific identifications which are already on the film strip.

11. The system comprising:
an apparatus as set forth in claim 1; and
a film strip as set forth in claim 5.

12. Apparatus for the production of film tube, which can be filled with a filling material, from a film strip, comprising:
a length of film having a plurality of spaced apart printed markings thereon, the electromagnetic spectrum of the printed markings being outside visible light;
a filling pipe connectable to a filling machine for the filling material;
a shaping device surrounding the filling pipe for shaping the film strip into a film tube;
a sealing device arranged downstream of the shaping device in the filling ejection direction for sealing longitudinal edges of the film strip, which are adjacent after the shaping operation, to form a film tube;
an advance drive for the film tube;
a first reading device arranged downstream of the shaping device in the filling ejection direction and a second reading device arranged upstream of the shaping device in the filling ejection direction for reading the printed markings applied to the film strip,
where the first and the second reading devices are capable of detecting said printed markings.

13. The apparatus as set forth in claim 12 where the electromagnetic spectrum of the printed markings is in a wavelength range which is less than 380 nm and greater than 780 nm.

14. The apparatus as set forth in claim 13 where the electromagnetic spectrum of the printed markings is in a wavelength range which is less than 350 nm and greater than 800 nm.
